(19) United States
(12) Patent Application Publication
(10) Pub. No.: US 2010/0139175 A1
(43) Pub. Date: Jun. 10, 2010

(54) Method and Apparatus for Distributing a Load About an Air Beam

(75) Inventors: Harold Warner, Calgary (CA); Stanislaw A. Lukasiewicz, Calgary (CA)

Correspondence Address: DIEDERIKS & WHITELAW, PLC, 13885 HEDGEWOOD DR., SUITE 317, WOODBRIDGE, VA, 22193, US

(73) Assignee: DYNAMIC SHELTERS, INC., Calgary, AB (CA)

(21) Appl. No.: 12/555,254

(22) Filed: Sep. 8, 2009

Related U.S. Application Data
(60) Provisional application No. 61/094,727, filed on Sep. 5, 2008.

(51) Int. Cl. E04C 3/00; E04H 15/20; F16B 7/00

(52) U.S. Cl. 52/2.11; 52/741.1; 403/26

(57) ABSTRACT

An apparatus for connecting an attachment and an air beam comprising a hug strap attached to a hug strap pad, the hug strap adapted to connect with the attachment, and the hug strap pad adapted to attach to the air beam. A method of securing an attachment to an air beam comprising providing an air beam, attaching a hug strap to a hug strap pad, securing the hug strap pad (with the hug strap attached) to the air beam, and securing the attachment to the hug strap.

### CROSS REFERENCE TO RELATED APPLICATIONS

This application claims the benefit of priority of U.S. Provisional Patent Application No. 61/094,727 filed Sep. 5, 2008, which is incorporated herein by reference in its entirety.

### FIELD OF THE INVENTION

The present invention relates generally to static structures. More particularly, the present invention relates to air beam construction static structures.

### BACKGROUND OF THE INVENTION

Inflatable structural members, commonly referred to as “air beams” may be assembled to form large inflatable shelters. The pneumatic columns may be difficult to connect with other structural elements/attachments due to their relative weakness and susceptibility to puncture. This can make them difficult to incorporate into structures and attachment to footings/anchors/guy wires, supports etc.

It is, therefore, desirable to provide a method and apparatus for distributing the attachment point loading for air beam structures.

### SUMMARY OF THE INVENTION

It is an object of the present invention to obviate or mitigate at least one disadvantage of previous methods and apparatus for distributing the attachment point loading for air beam structures.

In a first aspect, the present invention provides an apparatus for connecting an attachment and an air beam comprising a hug strap attached to a hug strap pad, the hug strap adapted to connect with the attachment, and the hug strap pad adapted to attach to the air beam.

In one embodiment, the hug strap pad is adapted to attach to the air beam about the perimeter of the air beam.

In one embodiment, the hug strap attached to the hug strap pad by stitching. In one embodiment, the hug strap pad attached to the air beam by welding.

In one embodiment, the hug strap pad comprising an elongate strap. In one embodiment, the hug strap comprising an elongate strap.

In one embodiment, the attachment selected from a guy wire, a reinforcing member, a cable, or a combination thereof.

In one embodiment, the hug strap is color coded to identify a design parameter. In one embodiment, the design parameter is selected from the group of design strength, design usage, year of manufacture, sequence of assembly or a combination thereof.

In one embodiment, the hug strap extending between a first end and a second end, each of the first end and the second end having an end connector, the end connector adapted to receive an end link member.

In one embodiment, the end connector including a loop or grommet.

In one embodiment, the hug strap further includes an intermediate connector, between the first end and the second end, the intermediate connector adapted to receive an intermediate link member.

In one embodiment, the intermediate connector including a loop or a grommet.

In one embodiment, the apparatus further includes a standoff extending between the hug strap and the intermediate connector.

In one embodiment, the end link member includes a quick link. In one embodiment, the intermediate link member includes a d-ring.

In a further aspect, the present invention provides an air beam having a hug strap for connecting an attachment and the air beam including an elongate pneumatic tubular column, the hug strap attached to a hug strap pad, the hug strap adapted to connect with the attachment, and the hug strap pad attached to the pneumatic tubular column.

In one embodiment, the hug strap pad attached to the air beam about the perimeter of the pneumatic tubular column.

In one embodiment, the hug strap attached to the hug strap pad by stitching.

In one embodiment, the hug strap pad attached to the pneumatic tubular column by welding.

In a further aspect, the present invention provides a method of securing an attachment to an air beam including providing an air beam, attaching a hug strap to a hug strap pad, securing the hug strap pad, with the hug strap attached, to the air beam, and securing the attachment to the hug strap.

In one embodiment, the hug strap and the hug strap pad are attached by stitching. In one embodiment, the hug strap pad and the air beam are attached by welding.

In a further aspect, the present invention provides an apparatus for connecting a first air beam and a second air beam, including a first hug strap attached to a first hug strap pad, the first hug strap pad adapted to attach to the first air beam, a second hug strap attached to a second hug strap pad, the second hug strap pad adapted to attach to the second air beam, and biasing means for biasing the first hug strap and the second hug strap together. In one embodiment, the biasing means comprises a ratchet assembly.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an isometric exploded view of an apparatus of the present invention;

FIG. 2 is a top view of the apparatus of FIG. 1 laid flat;

FIG. 3 a cross-section of an air beam column with the apparatus of FIG. 1;

FIG. 4 is an isometric view of an apparatus of the present invention with air beam columns;

FIG. 5 is a cross-section of one of the air beam columns of FIG. 4;

FIG. 6 is a isometric detail of one of the air beam columns of FIG. 4;

FIG. 7 is an isometric view of the apparatus of FIG. 1, shown with an attachment in the form of a fly;

FIG. 8 is a detail view of the apparatus of FIG. 7;

FIG. 9 is a detail view of the apparatus of FIG. 7;

FIG. 10 is an isometric view of an apparatus of the present invention in the form of an axial/longitudinal embodiment;

FIG. 11 is a section view of an air beam with a hug strap of the present invention;

FIG. 12 is a section view of an air beam with a hug strap of the present invention;

FIG. 13 is a top section of the air beam of FIG. 12; and

FIG. 14 is a cutaway section of an air beam structure using a hug strap of the present invention.

### DETAILED DESCRIPTION

Generally, the present invention provides a method and system for providing an attachment connection for connecting with a pneumatic tubular columns (arches) such as air beams.

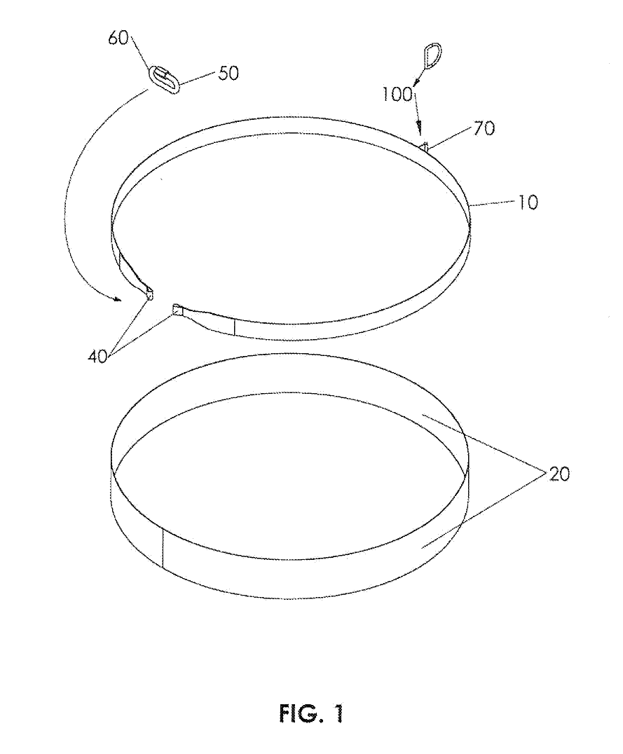

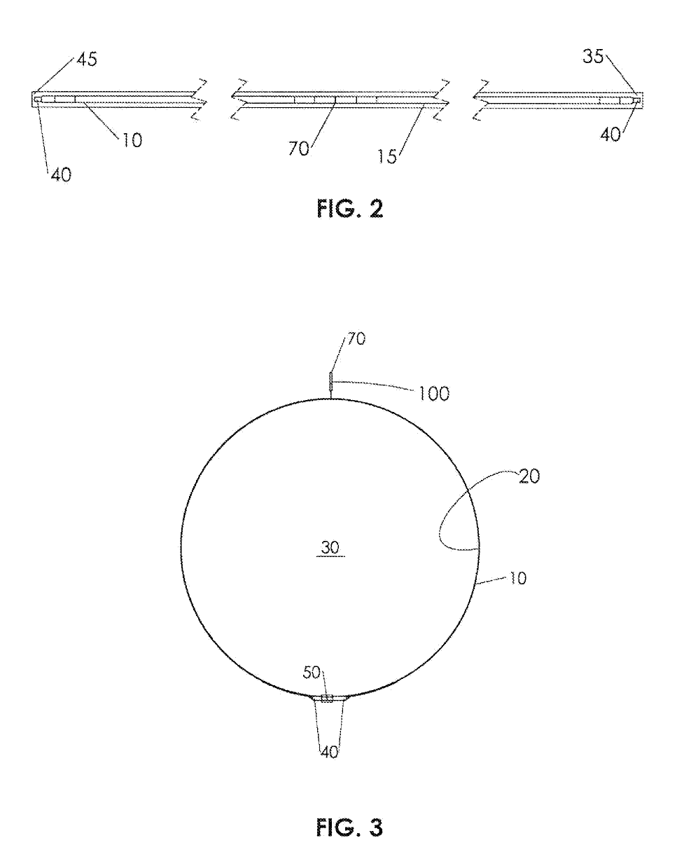

Referring to FIGS. 1-3, a hug strap 10 is attached to a hug strap pad 20. The hug strap pad 20 is then attached to an air beam 30 (FIG. 3). The hug strap pad 20 and hug strap 10 are connected by sewing, stitching, adhesive, or other means. This allows the hug strap 20 to be securely attached to the air beam 30 without risk to the pneumatic integrity of the air beam 30.

The connection between the hug strap 10 and the hug strap pad 20 may be intermittent or spot or may be substantially continuous along the perimeter (e.g. circumference for cylindrical tube shown). The hug strap pad 20 and the air beam 30 (FIG. 3) are connected by welding, bonding, adhesive, fusing, or other means. The connection between the hug strap pad 20 and the air beam 30 (FIG. 3) may be intermittent or spot or may be substantially continuous along the perimeter (e.g. circumference for cylindrical tube shown). The hug strap 10 is generally a stronger flexible material, such as nylon. The hug strap pad 20 is generally a weaker flexible material, compatible with the air beam 30, such as vinyl or poly vinyl chloride (PVC). The hug strap pad 20 may be wider than the hug strap 10 to provide for a larger contact area with the air beam 30.

The hug strap 10 may include end loops 40, which may be connected with an end link member 50 such as a quick link or other device. The end link member 50 may provide an attachment point 60. An intermediate loop 70 may be provided, which may be connected with an intermediate link member 80, such as a d-link or other device. The intermediate link member 80 may provide an attachment point 90.

While shown as a single, substantially central or midpoint location of the hug strap 10, the intermediate loop may 70 be provided in another location, or plurality of locations. As an alternate to the end loop 40 or the intermediate loop 70, a grommet may be provided within the hug strap 10 or the standoff 100 or both.

The hug strap pad 20 and the hug strap 10 generally conform or ‘hug’ the perimeter surface of the air beam 30 (in the case of the air beam 30 shown having a circular cross section, the circumference). A standoff 100 may provide radial separation between the intermediate loop 70 and the hug strap 10.

While shown as extending about a perimeter (circumference) of the air beam 30, the hug strap pad 20 and hug strap 10 may alternatively extend only about a portion of the perimeter of the air beam 30.

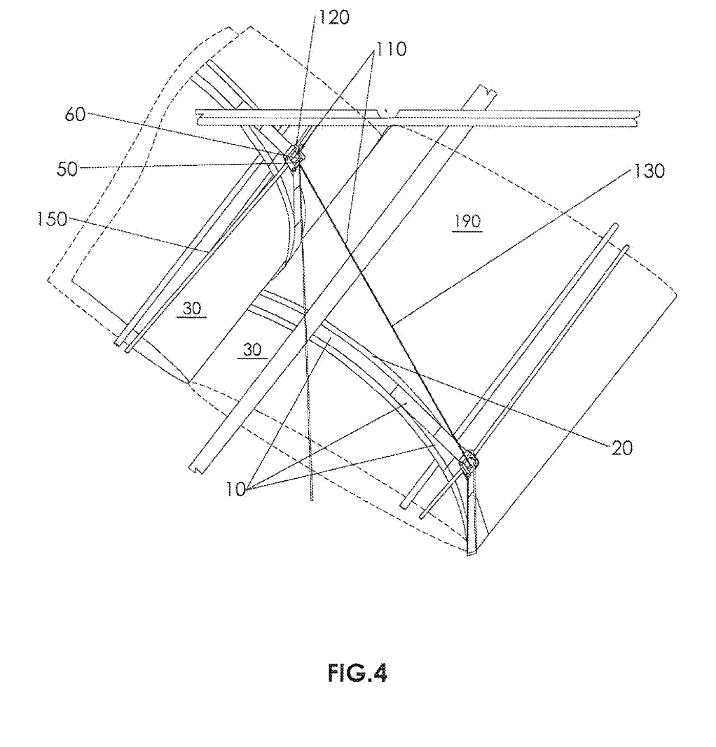

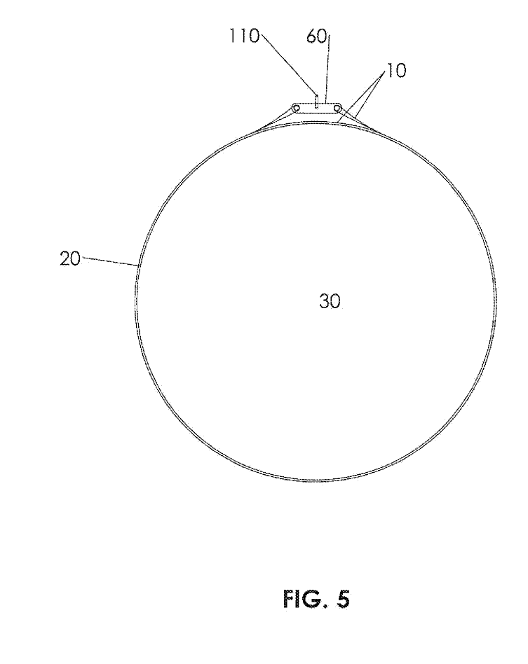

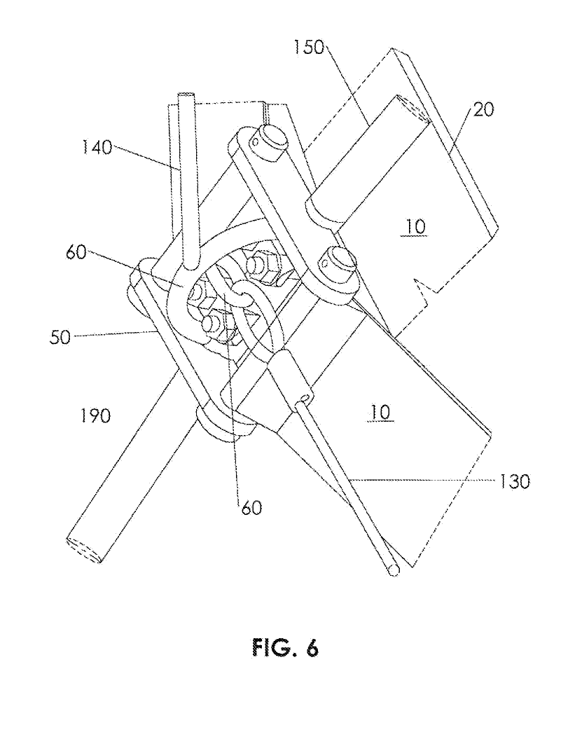

Referring to FIGS. 4-6, the apparatus of the present invention may be used to connect or attach a wide variety of attachments 110 and air beams 30, in a number of fixed or floating configurations or both. Referring to FIG. 4, a wide variety of attachments may be connected with the air beam 30 via the attachment point 60 or the attachment point 90 or both. The attachments may include a guy wire 140, a reinforcing member 150, a cable 130, or other attachment known to one skilled in the art, or a combination thereof.

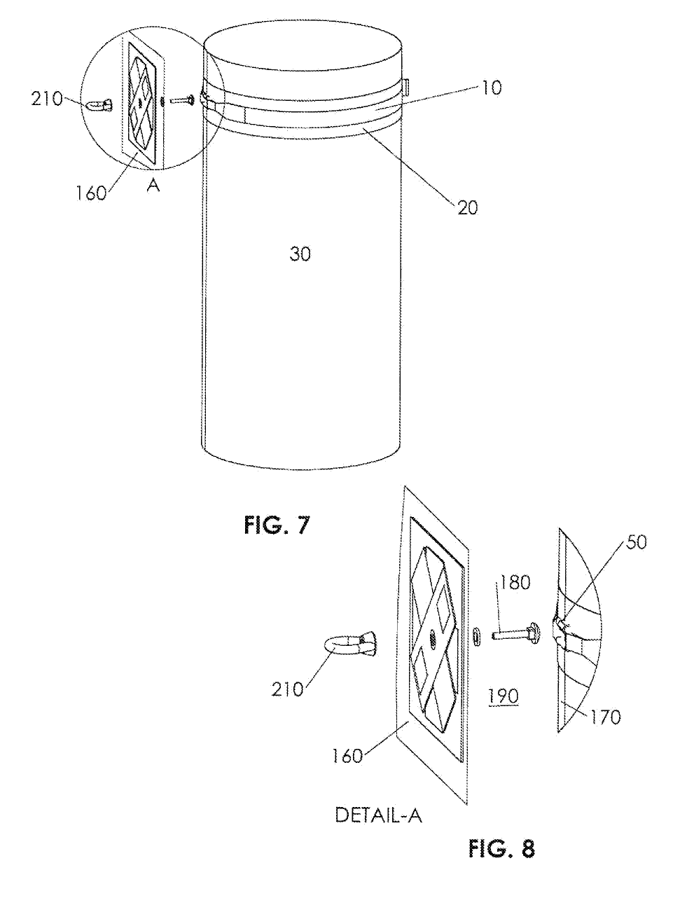

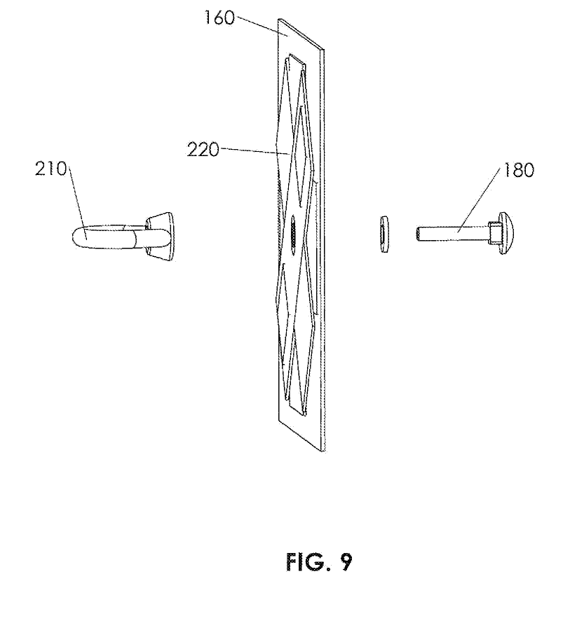

Referring to FIGS. 7-9, the apparatus of the present invention may be used to connect or attach a fly 160 or other flexible (or rigid or semi rigid) covering on the outside 190 or inside 190 or both of a number of the air beams 30 (forming a structure). A fastener 180 (e.g. bolt) may extend between the hug strap 10 through the fly 160 to provide a connection (e.g. eye nut 210) to the air beam 30 through the fly 160. A reinforcement 220 may be added around the fastener 180.

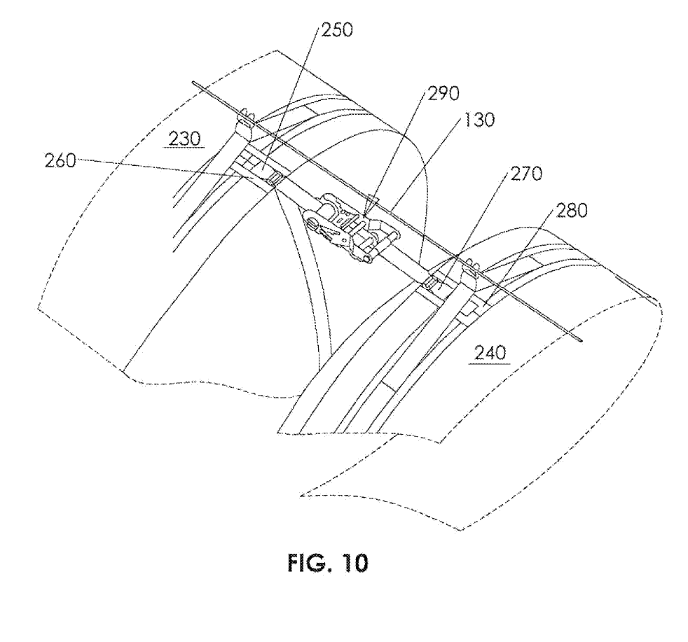

Referring to FIG. 10, apparatus of the present invention may be used to connect the air beams 30 (connect a first air beam 230 and a second air beam 240, for example end to end, as shown). A first hug strap 250 attaches to a first hug strap pad 260, and the first hug strap pad 250 attaches to the first air beam 230. A second hug strap 270 attaches to a second hug strap pad 280, and the second hug strap pad 280 attaches to the second air beam 240. The first hug strap 250 and the second hug strap 270 are fixed together by a cable 130 or otherwise, or may be drawn together and fixed in place, for example by a ratchet assembly 290. As shown, this axial connection may be combined with the perimeter design of FIGS. 1-9.

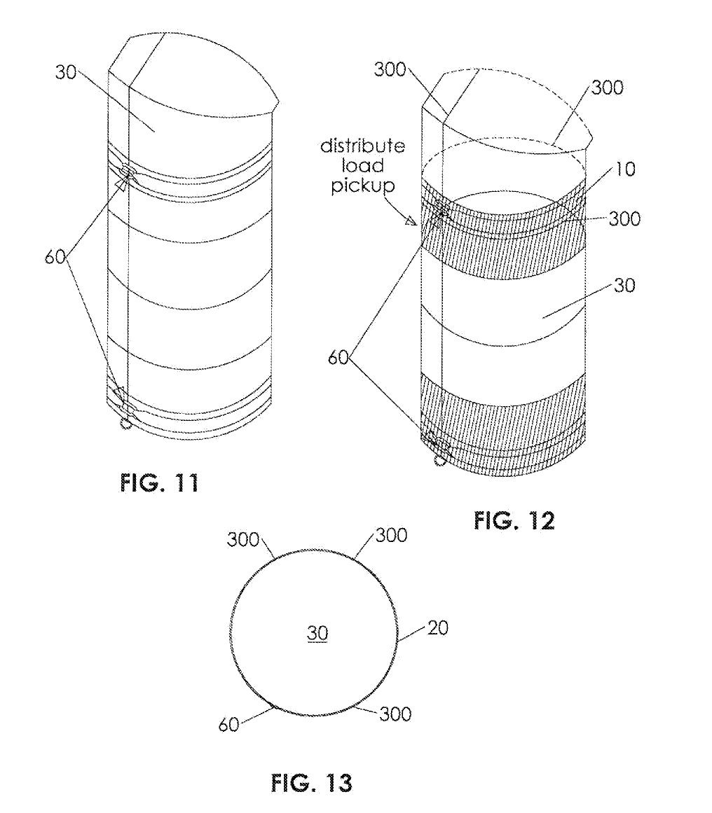

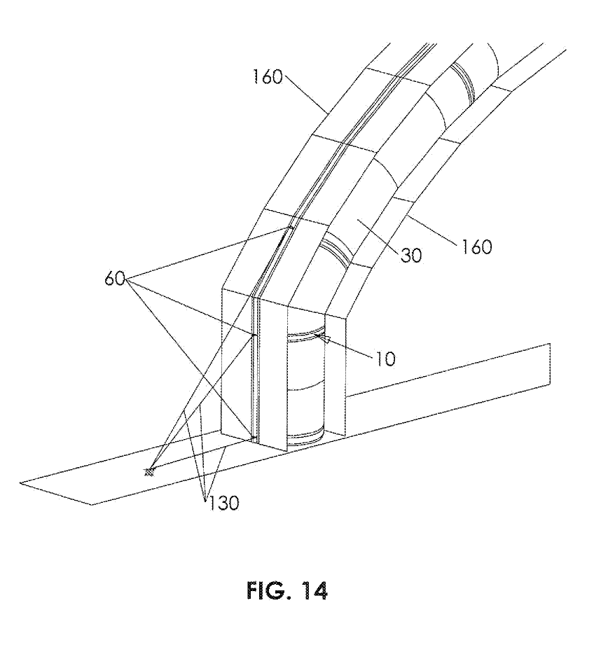

Referring to FIGS. 11-14, the hug strap 10 is shown in securing the air beam 30. The cables 130 extend between the attachment point 60 and an anchor to secure the structure. The hug strap 10 and the hug strap pad 20 or both may be relatively wide and may attach to the air beam 30 at a limited number of points (see FIGS. 12-13), for example by weld 300.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. An apparatus for connecting an attachment and an air beam comprising a hug strap attached to a hug strap pad, the hug strap adapted to connect with the attachment, and the hug strap pad adapted to attach to the air beam.

2. The apparatus of claim 1, the hug strap pad adapted to attach to the air beam about the perimeter of the air beam.

3. The apparatus of claim 1, the hug strap attached to the hug strap pad by stitching.

4. The apparatus of claim 1, the hug strap pad attached to the air beam by welding.

5. The apparatus of claim 1, the hug strap pad comprising an elongate strap.

6. The apparatus of claim 1, the hug strap comprising an elongate strap.

7. The apparatus of claim 1, the attachment selected from a guy wire, a reinforcing member, a cable, or a combination thereof.

8. The apparatus of claim 1, wherein the hug strap is color coded to identify a design parameter.

9. The apparatus of claim 8, wherein the design parameter is selected from the group of design strength, design usage, year of manufacture, sequence of assembly.

10. The apparatus of claim 1, the hug strap extending between a first end and a second end, each of the first end and the second end having an end connector, the end connector adapted to receive an end link member.

11. The apparatus of claim 10, the end connector comprising a loop or grommet.

12. The apparatus of claim 10, the hug strap further comprising an intermediate connector, between the first end and the second end, the intermediate connector adapted to receive an intermediate link member.

13. The apparatus of claim 12, the intermediate connector comprising a loop or a grommet.

14. The apparatus of claim 12, further comprising a standoff extending between the hug strap and the intermediate connector.

15. The apparatus of claim 12, the end link member comprising a quick link.

16. The apparatus of claim 12, the intermediate link member comprising a d-ring.

17. An air beam having a hug strap for connecting an attachment and the air beam comprising:
a. an elongate pneumatic tubular column;
b. the hug strap attached to a hug strap pad, the hug strap adapted to connect with the attachment, and the hug strap pad attached to the pneumatic tubular column.

18. The air beam of claim 17, the hug strap pad attached to the air beam about the perimeter of the pneumatic tubular column.

19. The air beam of claim 17, the hug strap attached to the hug strap pad by stitching.

20. The air beam of claim 17, the hug strap pad attached to the pneumatic tubular column by welding.

21. A method of securing an attachment to an air beam comprising:
a. providing an air beam;
b. attaching a hug strap to a hug strap pad;
c. securing the hug strap pad, with the hug strap attached, to the air beam; and
d. securing the attachment to the hug strap.

22. The method of claim 21, wherein the hug strap and the hug strap pad are attached by stitching.

23. The method of claim 21, wherein the hug strap pad and the air beam are attached by welding.

24. An apparatus for connecting a first air beam and a second air beam, comprising:
a. a first hug strap attached to a first hug strap pad, the first hug strap pad adapted to attach to the first air beam;
b. a second hug strap attached to a second hug strap pad, the second hug strap pad adapted to attach to the second air beam; and
c. biasing means for biasing the first hug strap and the second hug strap together.

25. The apparatus of claim 24, wherein the biasing means comprises a ratchet assembly.
